(19) United States
(12) Patent Application Publication
(10) Pub. No.: US 2022/0030995 A1
(43) Pub. Date: Feb. 3, 2022

(54) PERFECTED SELF-MODELLING PADDING, GARMENT OR SUPPORT COMPRISING SAID SELF-MODELLING PADDING, AND MANUFACTURING METHOD THEREOF

(71) Applicant: SELLE ITALIA S.R.L., Asolo (Treviso) (IT)

(72) Inventors: Giuseppe BIGOLIN, Asolo (Treviso) (IT); Riccardo PEROTTO, Asolo (Treviso) (IT)

(21) Appl. No.: 17/388,542

(22) Filed: Jul. 29, 2021

(30) Foreign Application Priority Data
Jul. 30, 2020 (IT) 102020000018607

(51) Int. Cl. A41D 31/28; A41D 13/06; F16F 9/30; F16F 9/53

(52) U.S. Cl. CPC A41D 31/28; A41D 13/065; F16F 2224/041; F16F 9/53; F16F 9/30

(57) ABSTRACT

A self-modelling padding for garments or supports which has an elastomeric matrix having a cross-linked, three-dimensional open cell structure, and a self-modelling paste embedded in the elastomeric matrix is provided. The elastomeric matrix is configured to have a shape memory. The self-modelling paste has a plastic behavior.

### CROSS-REFERENCE TO RELATED APPLICATION

This application claims priority to and benefit of Italian Patent Application No. 102020000018607 filed Jul. 30, 2020, the contents of which are incorporated by reference in their entirety.

### FIELD OF THE INVENTION

The present invention relates to an improved self-modelling padding, a garment or support comprising said self-modelling padding, and the manufacturing method thereof.

### BACKGROUND OF THE INVENTION

Use of padding for garments is particularly well-known in sports to create a cushioning pad capable of improving comfort of the garment itself or between the user and a support, such as a seat, a saddle of a bicycle or motorcycle, a backrest, a shoe insole, a handlebar grip cover, a protective garment, a protection for elbows, knees, shoulders and so on.

The same applies, for example, not only to footwear, but also to gloves, helmets and so on.

Therefore, it is apparent that the problem of comfort applies to a variety of sports and other sectors.

Such a problem has been widely addressed in the background art through the creation of special inserts or pads which have the function of limiting/dampening shocks, vibrations, and rubbing with the user's anatomical parts.

Nevertheless, known solutions fail to ensure comfort over time. In general, the solutions of the prior art provide use of shock-absorbing pads or inserts which tend to dampen shock and chafing. Such inserts or pads, however, fail to ensure the right balance between shock absorption and adaptability to the anatomical parts of the user, with the result that they are too rigid or too soggy, especially in prolonged use.

### SUMMARY OF THE INVENTION

Therefore, the need is felt to overcome the drawbacks and limitations mentioned above with reference to the prior art.

Such need is met by a self-modelling padding, a garment and a manufacturing method as described and claimed herein.

### BRIEF DESCRIPTION OF THE DRAWINGS

Further features and advantages of the present invention will become more comprehensible from the following description of preferred embodiments given by way of non-limiting examples, in which:

FIGS. 1a-1b show a front view and a perspective view, respectively, of a self-modelling paste for a padding according to an embodiment of the present invention;

FIGS. 2a-2b show a front view and a perspective view, respectively, of a 3D cross-linked open-cell elastomeric matrix for a padding according to an embodiment of the present invention;

FIGS. 3a-3b show a front view and a perspective view, respectively, of a 3D cross-linked and 2D-shaped open-cell elastomeric matrix for a padding according to an embodiment of the present invention;

FIGS. 4a-4b show a front view and a perspective view, respectively, of a 3D cross-linked and 3D-shaped open-cell elastomeric matrix for a padding according to an embodiment of the present invention;

FIG. 5 shows a perspective view of a padding, according to an embodiment of the present invention;

FIG. 6 shows a perspective view of a garment provided with a padding according to an embodiment of the present invention; such a padding may have different shapes and positions, including, for example, a trouser bottom, a knee protector, and the like; and

FIG. 7 shows a perspective view of a support provided with a padding according to an embodiment of the present invention.

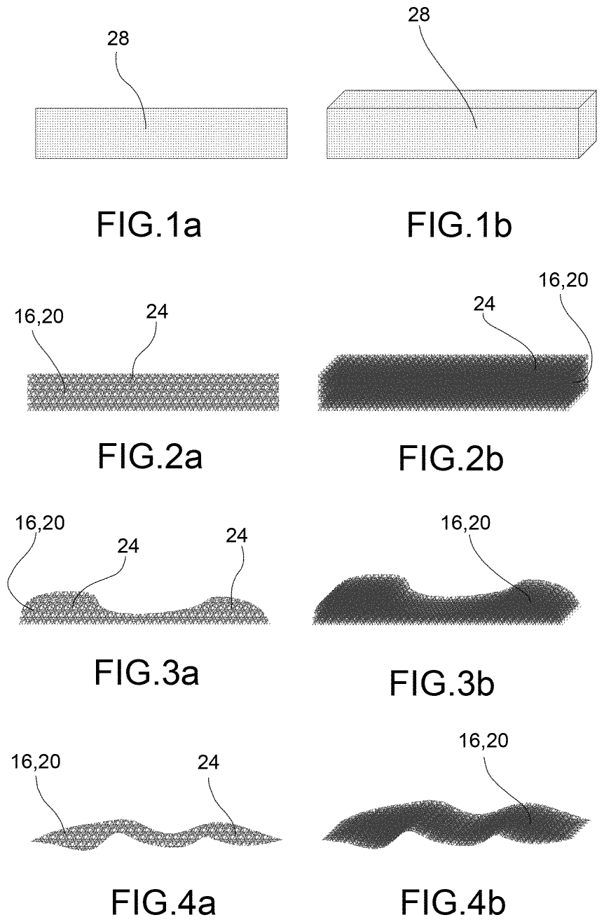

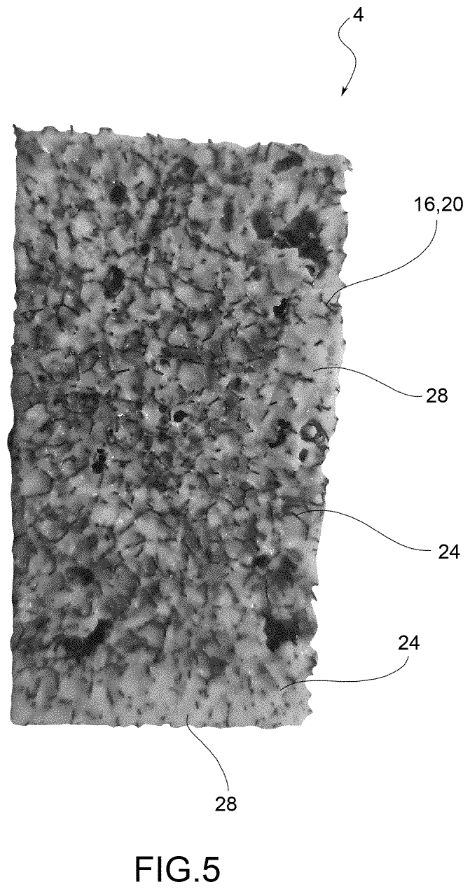

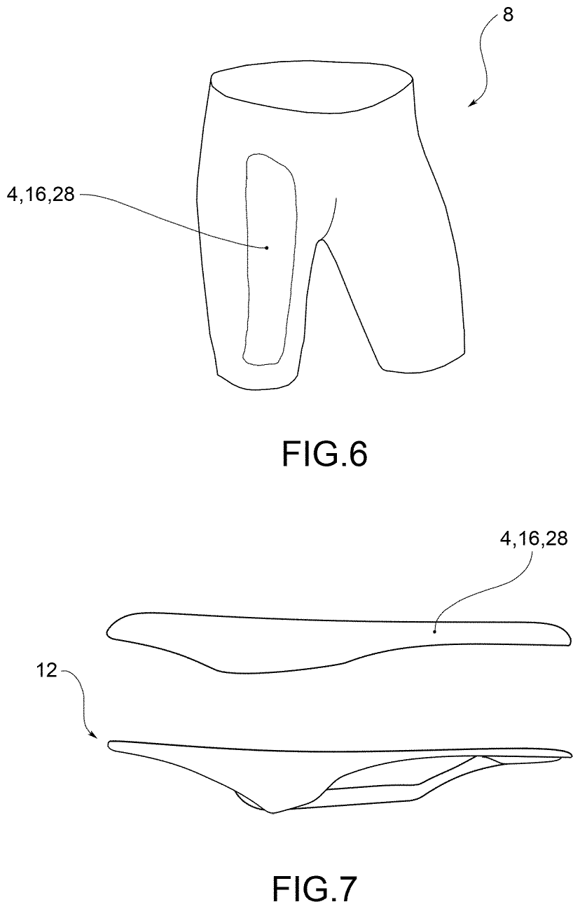

Elements or parts in common to the embodiments described will be indicated hereinafter using the same reference numerals.

### DETAILED DESCRIPTION

With reference to the figures, reference numeral 4 indicates a self-modelling padding as a whole in particular for garments 8 or supports 12.

It is worth noting that the concept of garment must be understood in a broad sense; therefore, it includes both sports garments and garments of any kind, such as gloves, shoes, ski boots, helmets and the like.

The same applies to the concept of support which may include, for example, seating elements, seats for vehicles, saddles for cycles or motorcycles, backrests, knobs and so on.

The self-modelling padding 4 comprises an elastomeric matrix 16, comprising a cross-linked, three-dimensional structure 20 with open cells 24.

Preferably, the elastomeric matrix 16 has a density comprised between 20 kg/m³ and 200 kg/m³.

According to a possible embodiment, the elastomeric matrix 16 has a three-dimensional geometry with open cells 24 of polyhedral shape.

The open cells may have a spherical shape with a diameter comprised from 0.2 mm to 15 mm. The open cells may be created by natural expansion, pre-built from a mould, or made by 3D printing.

According to a possible embodiment, the elastomeric matrix 16 has a proportion of voids, consisting of open cells 24, and solids, consisting of a grid delimiting the open cells 24, of not less than 50%.

Advantageously, the elastomeric matrix 16 is configured to have a shape memory. In other words, the elastomeric matrix has a well-defined geometric shape to which the elastomeric matrix 16 will tend to elastically return whenever it is subjected to external deformation.

An elastomeric matrix 16 comprising either normal or cross-linked open-cell PU foams 24 may be used. Usually, normal PU has smaller, more regular open cells 24, while cross-linked PU has larger, more irregular open cells 24.

The self-modelling padding 4 further comprises a self-modelling paste 28, embedded in the elastomeric matrix 16.

The self-modelling paste 28, taken individually, exhibits a plastic behavior. In other words, the self-modelling paste 28, if subjected to an external deformation, tends to remain plastically deformed, i.e., permanently deformed even when the external action ceases or, in any case, tends to return to the non-deformed configuration in an extremely long time, so as to be substantially a body with plastic behavior (i.e., without significant elastic return in the dynamic field).

According to an embodiment, the self-modelling paste 28 has a density comprised between 15 kg/m³ and 1000 kg/m³.

For example, the self-modelling paste 28 comprises at least one plant-based mouldable base or paste modified by at least one blowing agent, such as “Expancel”.

According to a possible embodiment, the self-modelling padding 4 comprises an outer coating (not shown) which surrounds the elastomeric matrix 16 and the self-modelling paste 28.

According to a possible embodiment, the garment 8 or support 12 has an elastomeric matrix 16 pre-formed to be at least partially counter-shaped relative to a portion or wall of the garment 8.

In other words, the elastomeric matrix can be pre-shaped so that its shape memory tends to elastically return the self-modelling padding 4 to a specific geometry adapted to achieve the function of the garment (e.g., a knee pad) or of the support (e.g., a bicycle seat).

A manufacturing method of a self-modelling padding, particularly for garments or supports, according to the present invention will now be described.

In particular, the method comprises:

providing an elastomeric matrix 16, comprising a three-dimensional, cross-linked structure 20 with open cells 24, in which the elastomeric matrix 16 is configured to have a shape memory,

providing a self-modelling paste 28 with plastic behavior, and

embedding the self-modelling paste 28 in the elastomeric matrix 16.

According to a possible embodiment, embedding the self-modelling paste 28 in the elastomeric matrix 16 comprises heating the self-modelling paste 28 to model it at the temperature indicated by the expander to be used (normally comprised between 80 degrees and 200 degrees centigrade), inserting the expander in the heated, self-modelling paste 28 which becomes liquid, mixing and waiting for it to expand.

Once the self-modelling paste 28 is cooled, it is dropped into the elastomeric matrix 16 by appropriate cylinders (normally at low pressure, but it could also be at high pressure). A step of pre-die-cutting the padding 4, which will then be welded, preferably by HF welding, between two retaining membranes, is also provided.

The present invention further relates to a method of making a garment 8 or support 12, comprising:

providing a garment 8 or support 12 suitable for interfacing with an anatomical part of a user on at least one interface wall,

providing a self-modelling padding 4 having an elastomeric matrix 16 at least partially counter-shaped with respect to the at least one interface wall, and

joining the self-modelling padding 4 to the at least one interface wall.

As can be appreciated from the above description, the present invention makes it possible to overcome the drawbacks of the prior art.

In particular, the self-modelling padding is easily deformable and adaptable to the anatomical conformation of the user wearing it or with which the user interfaces.

In particular, as described above, the padding consists of the union of a self-modelling paste, substantially free from shape memory, and an elastomeric matrix with shape memory.

The self-modelling paste by itself cannot maintain a specific shape or geometry with an elastic return, but it changes continuously according to the stresses it receives from the outside. Therefore, the self-modelling paste cannot adapt quickly and dynamically to external stresses and deformations due to the user. Furthermore, in case of impacts or contacts between parts, the self-modelling paste tends to change its shape slowly and in an inelastic manner. In other words, the paste tends to deform locally and return only partially towards an initial configuration, in an extremely long time. This means that the self-modelling paste, taken individually, is unable to dynamically adapt to external stresses.

On the other hand, the elastomeric matrix, provided with shape memory, can control the deformation of the self-modelling paste.

Indeed, the elastomeric matrix can deform and elastically return to its initial position (shape memory) in a short time, adapting to external stresses and deformations.

The elastomeric matrix, by virtue of the fact that it incorporates the self-modelling paste, can draw the self-modelling paste in its own elastic recovery motion. In other words, the elastomeric matrix guides the elastic recovery of the padding, also drawing the self-modelling paste with it, which instead would exhibit plastic behavior (permanent deformation as a result of external stress).

For this purpose, it is important that the self-modelling paste is uniformly distributed within the elastomeric matrix; for this reason, the elastomeric matrix preferably has an open-cell lattice structure, so that it can permeate (and thus bias) the entire mass of self-modelling paste in a uniform manner.

In this manner, the padding deformation at any point is distributed over a larger (neighbouring) area to dissipate the impact energy over a larger area and in a manner that involves a greater mass to avoid excessive localized deformation.

The connection between the various parts of the self-modelling paste, through the open cells of the elastomeric matrix, makes it possible to distribute the impact force, the rubbing energy and so on more uniformly and homogeneously. Elastic recovery, which is also rapid, is always guaranteed by the shape memory of the elastomeric matrix.

A person skilled in the art may, to satisfy contingent needs, make modifications to the solutions described above, while remaining within the scope of protection as described and claimed herein.

What is claimed is:

1. A self-modelling padding for garments or supports, comprising:
an elastomeric matrix, comprising a cross-linked, three-dimensional structure with open cells, and
a self-modelling paste, embedded in said elastomeric matrix,
wherein said elastomeric matrix is configured to present a shape memory, and
wherein said self-modelling paste has a plastic behavior.

2. The self-modelling padding of claim 1, wherein the elastomeric matrix has a density between 20 kg/m³ and 200 kg/m³.

3. The self-modelling padding of claim 1, wherein the self-modelling paste has a density between 15 kg/m³ and 1000 kg/m³.

4. The self-modelling padding of claims 1, wherein the elastomeric matrix has a three-dimensional geometry with open cells of polyhedral shape.

5. The self-modelling padding of claims 1, wherein the elastomeric matrix has a three-dimensional geometry with open cells of spherical shape with a diameter between 0.2 mm and 15 mm.

6. The self-modelling padding of claims 1, wherein said elastomeric matrix has a proportion of voids, consisting of open cells, and solids, consisting of a grid delimiting said open cells, of not less than 50%.

7. The self-modelling padding of claim 1, wherein said self-modelling paste comprises a vegetable modelling paste with at least one expander added.

8. The self-modelling padding of claim 7, wherein said at least one expander comprises Expancel.

9. The self-modelling padding of claim 1, wherein said elastomeric matrix comprises normal or cross-linked open-cell polyurethane foam.

10. The self-modelling padding ( of claim 1, further comprising an outer coating that encloses the elastomeric matrix and the self-modelling paste.

11. The self-modelling padding of claims 1, wherein the self-modelling paste is embedded in said elastomeric matrix seamlessly.

12. A garment or support comprising a self-modelling padding comprising:
an elastomeric matrix, comprising a cross-linked, three-dimensional structure with open cells, and
a self-modelling paste, embedded in said elastomeric matrix,
wherein said elastomeric matrix is configured to present a shape memory, and
wherein said self-modelling paste has a plastic behavior.

13. The garment or support of claim 12, wherein said elastomeric matrix is pre-formed so that said elastomeric matrix is at least partially counter-shaped to a portion or wall of said garment.

14. A method for making a self-modelling padding for garments or supports, the method comprising:
providing an elastomeric matrix, comprising a cross-linked, open cell three-dimensional structure in which the elastomeric matrix is configured to present a shape memory,
providing a self-modelling paste with plastic behavior, and
embedding the self-modelling paste in said elastomeric matrix.

15. The method of claim 14, wherein embedding the self-modelling paste in the elastomeric matrix comprises:
heating the self-modelling paste to shape the self-modelling paste at a temperature indicated by an expander to be used,
inserting the expander in the heated, self-modelling paste that becomes liquid, mixing and waiting for the self-modelling paste to expand,
waiting for the self-modelling paste to cool, and
dropping said self-modelling paste into the elastomeric matrix.

16. A method for making a garment or support, the method comprising:
providing a garment or support suitable for interfacing with an anatomical part of a user on at least one interface wall,
providing a self-modelling padding according to claim 1, having an elastomeric matrix at least partially counter-shaped to said at least one interface wall, and
joining said self-modelling padding to the at least one interface wall.
